(19) United States
(12) Patent Application Publication
(10) Pub. No.: US 2004/0000346 A1
(43) Pub. Date: Jan. 1, 2004

(54) Water pump structure by siphonage

(76) Inventor: Jenn-Feng Lin, Taichung (TW)

Correspondence Address: BACON & THOMAS, PLLC, 625 SLATERS LANE, FOURTH FLOOR, ALEXANDRIA, VA, 22314

(21) Appl. No.: 10/179,895

(22) Filed: Jun. 26, 2002

(51) Int. Cl. F16K 15/00

(52) U.S. Cl. 137/601.2

(57) ABSTRACT

A water pump structure comprises a bottom pipe, a top pipe, and a motor. The bottom pipe is provided with an outlet, and an inlet which is connected to a water source by a siphonage pipe. The top pipe is provided with an outlet, and an inlet which is connected with the outlet of the bottom pipe by a siphonage pipe. The top pipe and the bottom pipe is fastened end to end in conjunction with an ON-OFF valve. The motor is connected with the top pipe by a connection pipe which is engaged at one end with the outlet of the top pipe. The water in the top pipe is drawn up into a water storage tank by the motor. The top pipe is replenished with water by the bottom pipe by siphonage, whereas the bottom pipe is replenished with water by the water source by siphonage.

### FIELD OF THE INVENTION

The present invention relates generally to a water pump structure, and more particularly to an energy-efficient water pump structure by siphonage.

### BACKGROUND OF THE INVENTION

As illustrated in FIG. 1, a high-rise building is provided with a conventional water pump system comprising an underground reservoir 10, a motor 20 located at the top of the building, a water pipe 30 located between the reservoir 10 and the motor 20, a water storage tank 40 located at the top of the building and connected with the motor 20, and a water distribution pipe 50 connected to the water storage tank 40. In operation, water is pumped up by the motor 20 from the reservoir 10 to the water storage tank 40 via the water pipe 30. The water contained in the storage tank 40 is distributed to the occupants of the building via the water distribution pipe 50. In light of the distance between the underground reservoir 10 and the water storage tank 40 located at the top of the high-rise building, the act of pumping water by the motor 20 calls for a considerable consumption of energy. In other words, such conventional water pump system as described above is not cost-efficient at best.

### SUMMARY OF THE INVENTION

The primary objective of the present invention is to provided an energy-efficient water pump structure for transporting water from an underground water reservoir of a high-rise building to a water storage tank located at the top of the high-rise building. The water pump structure of the present invention comprises a bottom pipe, a top pipe, and a motor. The bottom pipe is in communication with the underground water reservoir and the top pipe. The top pipe is connected to the motor. As the water contained in the top pipe is pumped by the motor to the water storage tank, a vacuum is crested in the top pipe to draw the water up from the bottom pipe by the act of siphonage, thereby resulting in reduction in energy consumption by the motor.

The features and the advantages of the present invention will be more readily understood upon a thoughtful deliberation of the following detailed description of the preferred embodiments of the present invention with reference to the accompanying drawings.

### BRIEF DESCRIPTION OF THE DRAWINGS

FIG. 1 shows a schematic view of a water pump system of the prior art.

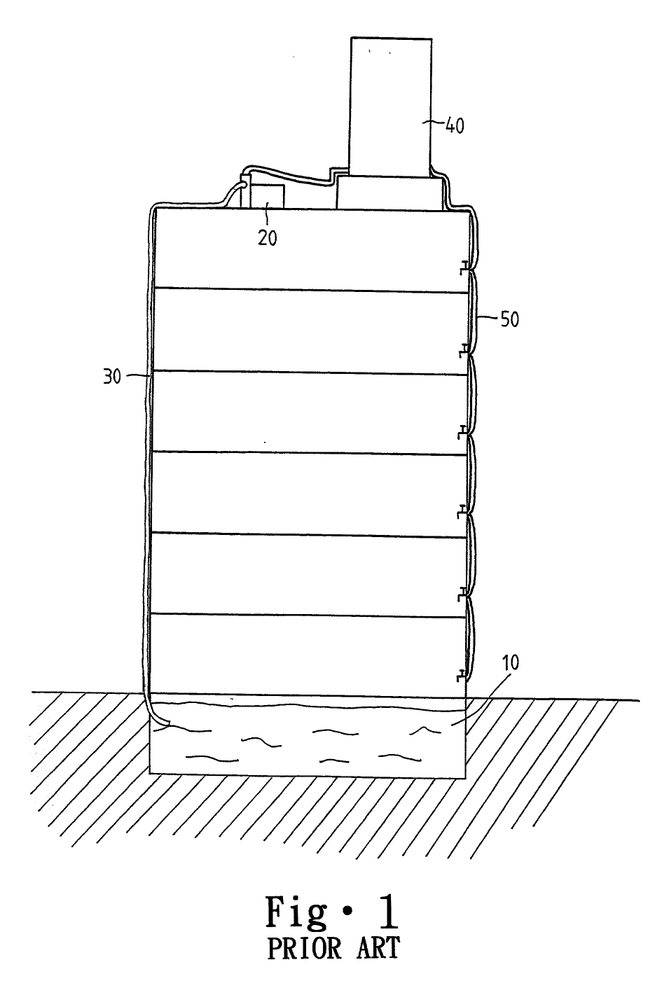

FIG. 2 shows a schematic view of a first preferred embodiment of the present invention.

FIG. 3 shows a schematic view of the first preferred embodiment of the present invention in action.

FIG. 4 shows a schematic view of a second preferred embodiment of the present invention.

FIG. 5 shows a schematic view of the second preferred embodiment of the present invention in action.

FIG. 6 shows a schematic view of the present invention in operation in a high-rise building.

### DETAILED DESCRIPTION OF THE PREFERRED EMBODIMENTS

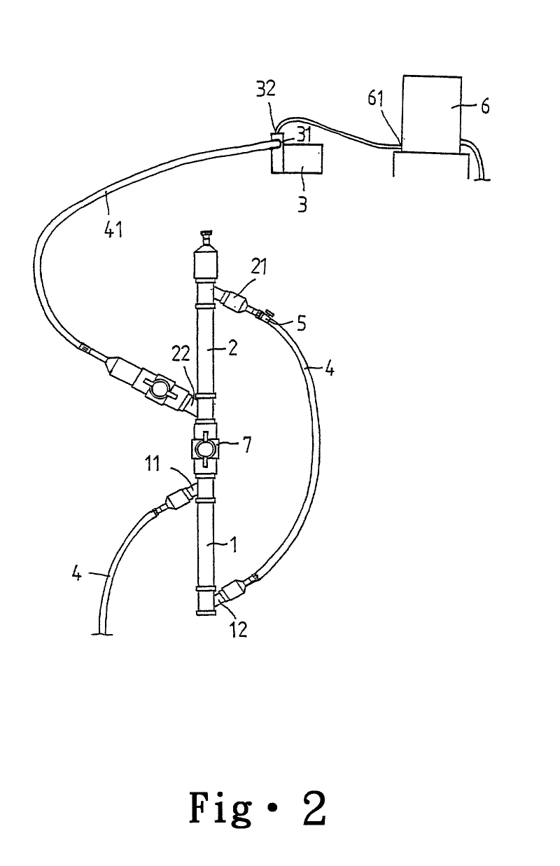

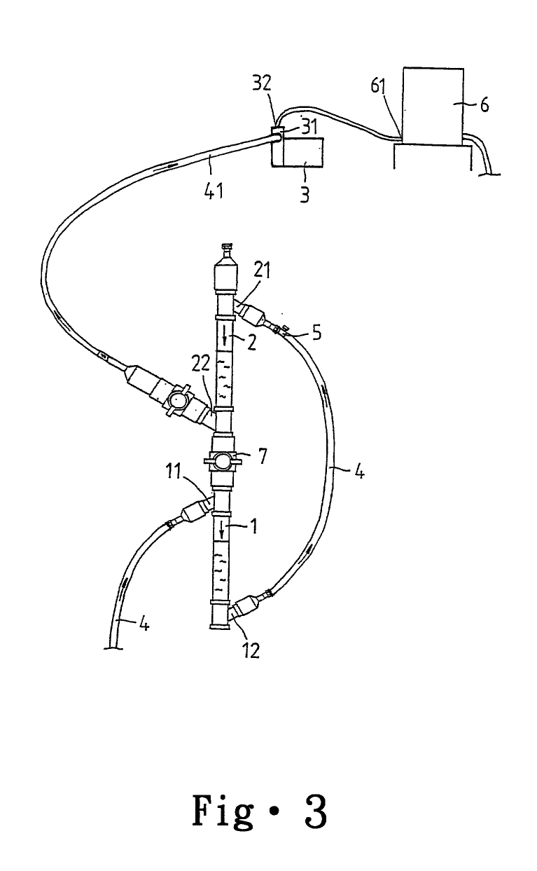

As shown in FIGS. 2 and 3, a water pump structure of the first preferred embodiment of the present invention comprises a bottom pipe 1, a top pipe 2, and a motor 3.

The bottom pipe 1 is provided in proximity of a top end thereof with a first inlet 11 which is in communication with a water source via a siphonage pipe 4. The bottom pipe 1 is further provided in proximity of a closed bottom end thereof with a first outlet 12.

The top pipe 2 is fastened at a bottom end with the top end of the bottom pipe 1 and is provided in proximity of a top closed end thereof with a second inlet 21, which is connected with the first outlet 12 of the bottom pipe 1 by a siphonage pipe 4 and is provided with a check valve 5. The top pipe 2 is provided in proximity of the bottom end with a second outlet 22.

The motor 3 is provided with a third inlet 31 and a third outlet 32. The third inlet 31 is connected with the second outlet 22 of the top pipe 2 by a connection pipe 41. The third outlet 32 of the motor 3 is connected with a fourth inlet 61 of a water storage tank 6 which is located at a higher level than the water source.

Located between the bottom pipe 1 and the top pipe 2 is an ON-OFF valve 7. When the valve 7 is turned on, the bottom pipe 1 is in communication with the top pipe 2. When the valve 7 is turned off, the bottom pipe 1 and the top pipe 2 are not in communication with each other, thereby forming two separate tubular bodies. As show in FIG. 3, the valve 7 is turned on to allow the two tubular bodies 1 and 2 to be filled with water of the water source. Thereafter, the valve 7 is turned off before the motor 3 is started. As soon as the motor 3 is started, the water in the top pipe 2 is drawn out of the top pipe 2 via the second outlet 22 such that the water is then pumped into the water storage tank 6 via the connection pipe 41, the third inlet 31, the third outlet 32, and the fourth inlet 61. As the water level in the top pipe 2 drops, a vacuum is created in the top pipe 2. As a result, the water in the bottom pipe 1 is drawn by suction into the top pipe 2 via the siphonage pipe 4 which connects the first outlet 12 of the bottom pipe 1 and the second inlet 21 of the top pipe 2. The reverse flow of the water is prevented by the check valve 5. In other word, as soon as the top pipe 2 is depleted with the water, the top pipe 2 is replenished with the water by the act of siphonage. Similarly, the water level in the bottom pipe 1 drops to create in the empty space a vacuum in the bottom pipe 1. As a result, the water in the water source is drawn by suction into the bottom pipe 1 via the first inlet 11 of the bottom pipe 1, which is in communication with the water source by the siphonage pipe 4.

In view of the fact that the bottom pipe 1 and the top pipe 2 are replenished with the water by the process of siphonage, and that the water is pumped into the water storage tank 6 by the motor 3, the energy consumption by the motor 3 is substantially reduced.

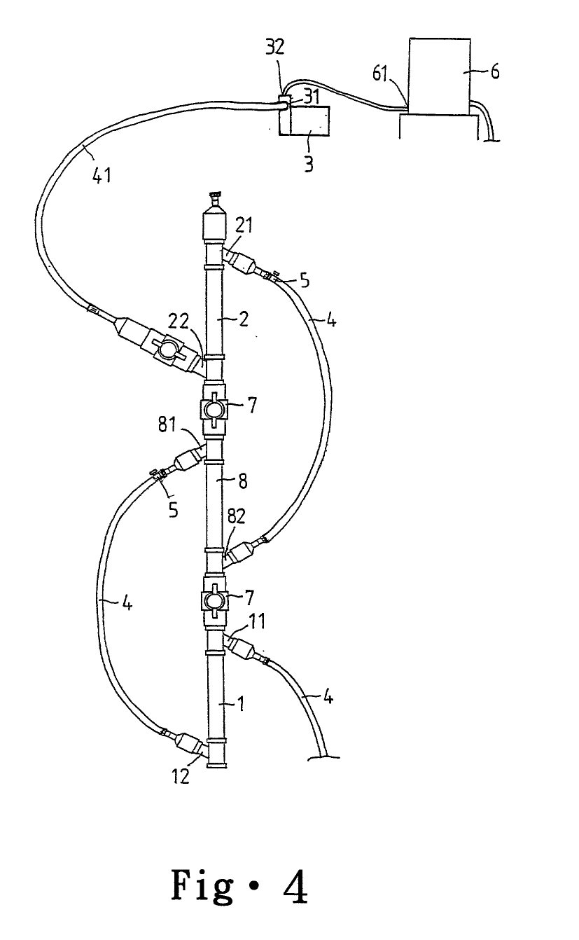

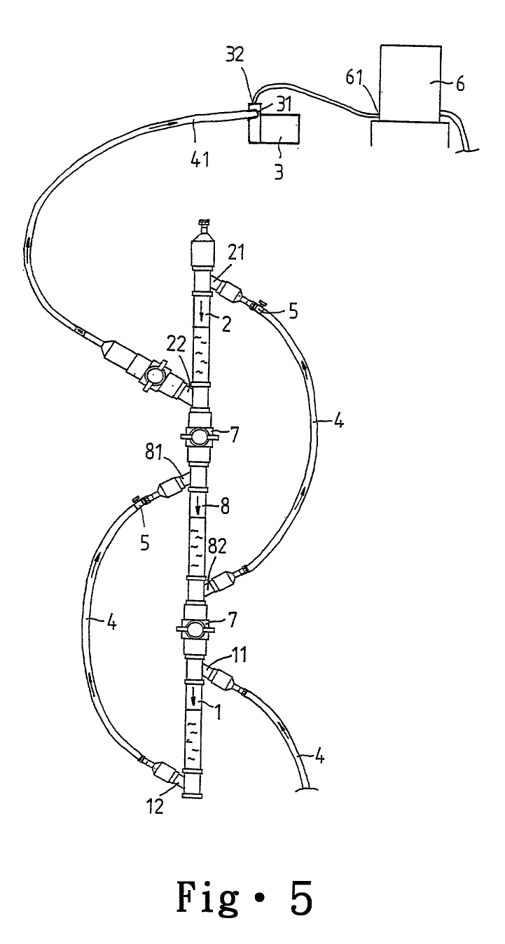

As shown in FIGS. 4 and 5, a water pump structure of the second preferred embodiment of the present invention is basically similar in construction to that of the first preferred embodiment described above, except that the former comprises an expansion pipe 8 which is fastened between the bottom pipe 1 and the top pipe 2 such that the expansion pipe 8 is fastened at a top end thereof with the bottom end of the top pipe 2, and that the expansion pipe 8 is fastened at a bottom end thereof with the top end of the bottom pipe 1, and further that the expansion pipe 8 is in communication with the bottom pipe 1 and the top pipe 2. Located between the expansion pipe 8 and the bottom pipe 1 or the top pipe 2 is an ON-OFF valve 7. The three pipes 1, 2, and 8 become three separate tubular bodies when the two valves 7 are turned off simultaneously.

The expansion pipe 8 is provided in proximity of the top end with a fifth inlet 81, and in proximity of the bottom end with a fifth outlet 82. The fifth inlet 81 is connected with the first outlet 12 of the bottom pipe 1 by a siphonage pipe 4 and is provided with a check valve 5. The fifth outlet 82 of the expansion pipe 8 is connected with the second inlet 21 of the top pipe 2 by a siphonage pipe 4. The second inlet 21 is provided with a check valve 5.

In operation, the two ON-OFF valves 7 are turned on so that the three pipes 1, 2, and 8 are in communication with one another. Thereafter, the three pipes 1, 2, and 8 are filled with water before the two valves 7 are turned off. As the motor 3 is started, the water in the top pipe 2 is drawn up into the water storage tank 6 via the second outlet 22 of the top pipe 2, the connection pipe 41, and the motor 3, thereby resulting in creation of a vacuum in empty space of the top pipe 2. As a result, the water in the expansion pipe 8 is subsequently drawn up into the top pipe 2 via the fifth outlet 82 of the expansion pipe 8, a siphonage pipe 4, and the second inlet 21 of the top pipe 2, as illustrated in FIG. 5. The transportation of the water from the expansion pipe 8 into the top pipe 2 is carried out by the act of siphonage. Similarly, the water is transported from the bottom pipe 1 into the expansion pipe 8 by the process of siphonage. The work done by the motor 3 is confined to the transportation of the water from the top pipe 1 into the water storage tank 6, thereby resulting in a substantial reduction in energy consumption by the motor 3. The water pump structure of the present invention is thus energy-efficient. The addition of the expansion pipe 8 depends on the length of the bottom pipe 1 and the op pipe 2 as well as the vertical distance between the water source and the water storage tank 6.

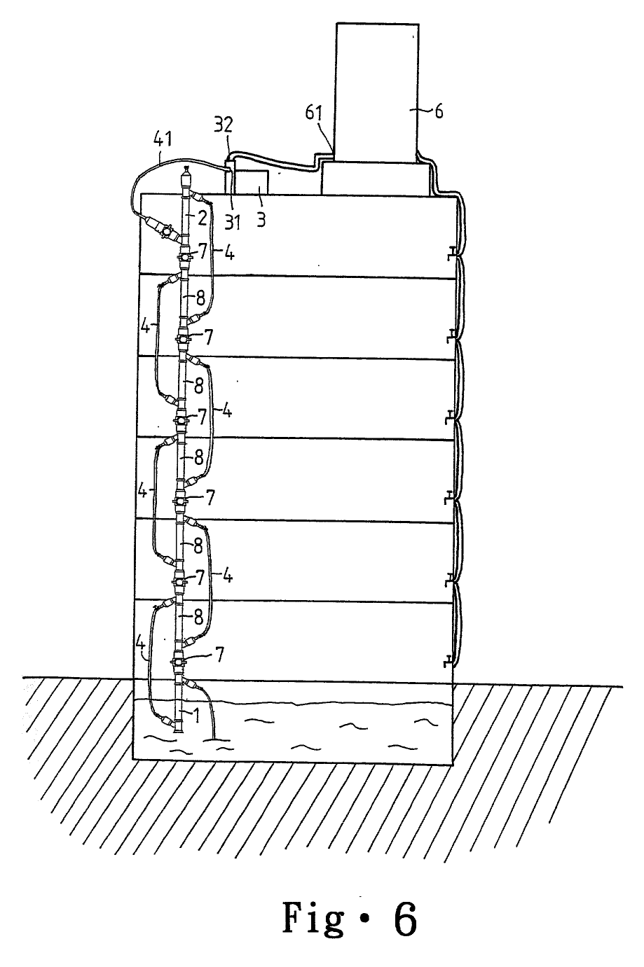

The embodiment of the present invention described above are to be regarded in all respects as being illustrative and nonrestrictive. Accordingly, the present invention may be embodied in other specific forms without deviating from the spirit thereof. For example, the structure of the present invention may comprises one or more expansion pipes 8, as shown in FIG. 6. The present invention is therefore to be limited only by the scopes of the following claims.

What is claimed is:

1. A water pump structure comprising:
a bottom pipe provided at a top end with an inlet, at a closed bottom end with an outlet, and a siphonage pipe connecting said inlet to a water source;
a top pipe provided at a closed top end with an inlet, at a bottom end with an outlet, and a siphonage pipe connecting said inlet of said top pipe with said outlet of said bottom pipe whereby said top pipe is fastened at the bottom end with the top end of said bottom pipe in conjunction with an ON-OFF valve such that said top pipe is in communication with said bottom pipe at the time when said ON-OFF valve is turned on, and that said top pipe is not in communication with said bottom pipe at the time when said ON-OFF valve is turned off; and
a motor located above said top pipe and connected with a water storage tank whereby said motor is further connected with said outlet of top pipe by a connection pipe.

2. The water pump structure as defined in claim 1, wherein said inlet of said top pipe is provided with a check valve.

3. The water pump structure as defined in claim 1 further comprising one or more expansion pipes which are fastened end to end in conjunction with an ON-OFF valve, with a topmost expansion pipe being fastened with said top pipe in conjunction with an ON-OFF valve, and with a bottommost expansion pipe being fastened with said bottom pipe in conjunction with an ON-OFF valve whereby said expansion pipe are provided at a top end thereof with an inlet, and at a bottom end thereof with an outlet, with said inlet of said expansion pipes being connected with said outlet of an adjoining expansion pipe by a siphonage pipe, with said outlet of the topmost expansion pipe being connected with said inlet of said top pipe by a siphonage pipe, and with said inlet of the bottommost expansion pipe being connected with said outlet of said bottom pipe by a siphonage pipe.

4. The water pump structure as defined in claim 3, wherein said inlet of each of said expansion pipes is provided with a check valve.
